(19) United States
(12) Patent Application Publication
(10) Pub. No.: US 2017/0049257 A1
(43) Pub. Date: Feb. 23, 2017

(54) STEAM COOKER

(71) Applicants: Winston L. Shelton, Louisville, KY (US); Steven S. Wilson, Louisville, KY (US); David B. Shelton, Louisville, KY (US)

(72) Inventors: Winston L. Shelton, Louisville, KY (US); Steven S. Wilson, Louisville, KY (US); David B. Shelton, Louisville, KY (US)

(21) Appl. No.: 15/238,942

(22) Filed: Aug. 17, 2016

Related U.S. Application Data
(60) Provisional application No. 62/205,946, filed on Aug. 17, 2015.

(51) Int. Cl. A47J 27/04; A23L 5/10

(52) U.S. Cl. CPC A47J 27/04; A23L 5/13; A47J 2027/043; A23V 2002/00

(57) ABSTRACT

Disclosed herein is a steam cooker. More specifically, the disclosed steam cooker is an apparatus for cooking food within a chamber to a specific wet bulb temperature by creating steam within the chamber. Steam is created by heating water vapor provided to the chamber. Completion of cooking is indicated when steam exits the chamber via a vent.

This application claims the benefit of priority to U.S. Provisional Patent Application No. 62/205,946, filed Aug. 17, 2015, entitled STEAM COOKER, the entirety of which is incorporated herein by reference.

### FIELD OF THE INVENTION

Disclosed herein is a steam cooker. More specifically, the disclosed steam cooker is an apparatus for cooking food within a chamber to a specific wet bulb temperature by creating steam within the chamber. Steam is created by heating water vapor provided to the chamber. Completion of cooking is indicated when steam exits the chamber via a vent.

### BACKGROUND OF THE INVENTION

Steam cookers, also referred to as food steamers, cook food and maintain food at an elevated temperature by applying steam to the food. In a typical steam cooker, food is placed in a chamber and steam is delivered to the chamber. Steam is typically produced by heating a body of water until it boils, then the resulting steam is directed into the chamber. However, boiling a body of water of sufficient size to produce sufficient steam for a steam cooker typically takes several minutes and is energy intensive. In some commercially available single phase steam cookers, comparable in size to exemplary steam cooker disclosed herein, production of sufficient steam requires 6 kilowatts to 12 kilowatts delivered at 240 volts. Also, typical steam cookers do not include a means to determine when food in the chamber has finished cooking and lack fine control of the temperature of food being cooked within. Instead, typical steam cookers use a manually settable timer to control the cook time and rely upon the judgment of a user to set an appropriate cook time based on the food load in the steam cooker. The standard practice in the commercial foodservice industry is to cook all foods to at least 165° F. to heat the foods sufficiently to reduce the risk of foodborne illness. However, this practice does not permit a consumer to enjoy some foods that would be available if it were feasible to determine when food had finished cooking at lower temperatures.

### SUMMARY

Embodiments of the present invention relate to equipment and methods for steam cooking food based on heating water vapor to produce steam. More particularly, some embodiments of the present invention relate to a steam cooker including a housing having a sealable chamber. Within the chamber or in communication with the chamber are a heater and at least one inlet for delivering water vapor into the chamber. A control system activates and deactivates the heater and the at least one inlet.

In usage, one or more cooking trays holding food are inserted into the chamber, and the chamber is sealed. The heater is activated and the inlet delivers water vapor at or near room temperature into the chamber. The heater causes a phase change in the water vapor, creating steam. Steam initially rises within the chamber, then builds downwards, enveloping the food. The steam raises the temperature of the food by transferring heat to the food, thereby cooking the food. When the steam builds downwards to an elevation below the lowest-positioned cooking tray, the steam exits the chamber via a vent to the exterior of the steam cooker. Upon exit, the steam cools and becomes visible, indicating to an operator that the food has finished cooking. In certain embodiments, the steam cooker includes a wet-bulb temperature sensor located within the chamber. A control system activates the heater and inlet when the sensor detects a wet-bulb temperature within the chamber lower than a desired temperature set by the operator, and deactivates the heater and inlet when the desired temperature is reached or exceeded.

In some embodiments, the present invention comprises a steam cooker including a housing including an exterior and a sealable chamber within the housing, the chamber having a top and a bottom; a heater connected to the chamber; at least one inlet for delivering water vapor into the chamber; and a vent providing atmospheric communication between the chamber and the exterior; and a control system connected to the heater and the at least one inlet, the control system controlling the heater to add heat to the chamber and controlling the at least one inlet to deliver water vapor into the chamber. In further embodiments, the steam cooker further includes a conduit having a first opening in the chamber and a second opening in the exterior of the housing. In certain embodiments, the first opening of the conduit is positioned below the vent within the chamber. In some embodiments, the heater is located within the chamber. In further embodiments, the at least one inlet is configured to deliver water vapor onto the heater. In further embodiments, the heater is configured to heat the water vapor within the chamber. In certain embodiments, the water vapor is delivered into the chamber at about room temperature. In some embodiments, the control system includes a temperature sensor for detecting a chamber temperature. In further embodiments, the control system includes a thermostat for setting a desired temperature. In certain embodiments, the control system activates the heater when the chamber temperature is less than the desired temperature and deactivates the heater when the chamber temperature is equal to or exceeds the desired temperature. In some embodiments, the temperature sensor is located within the chamber. In further embodiments, the temperature sensor is operatively connected to a heat conductor.

In further embodiments, the present invention comprises a method for cooking, including placing food within a chamber; providing water vapor into the chamber; heating the water vapor within the chamber; and contacting the food with the heated water vapor. In some embodiments, the method further includes establishing a desired temperature; and measuring a chamber temperature within the chamber; and wherein said heating occurs when the chamber temperature does not equal or exceed the desired temperature. In further embodiments, measuring a chamber temperature includes measuring a wet bulb chamber temperature. In certain embodiments, the method further includes determining completion of cooking; and removing food from the chamber after said determining. In some embodiments, said determining includes detecting egress of water vapor from the chamber. In further embodiments, said detecting includes observing egress of water vapor from the chamber. In certain embodiments the desired temperature is less than the boiling point of water. In some embodiments, said heating includes contacting a heater located within the chamber with the water vapor.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein is not necessarily intended to address every object described herein, and each embodiment does not necessarily include each feature described. Other forms, embodiments, objects, advantages, benefits, features, and aspects of the present invention will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1 depicts a top plan view of a first embodiment of a steam cooker with its upper panel removed;

FIG. 2A depicts a front elevation view of the steam cooker of FIG. 1;

FIG. 2B depicts a front-right side perspective view of the steam cooker of FIG. 1;

FIG. 2C depicts a rear-left side perspective view of the steam cooker of FIG. 1;

FIG. 3A depicts a front-right side perspective section view along lines A-A of FIG. 2A, the steam cooker containing two cooking trays;

FIG. 3B depicts a side elevation section view along lines A-A of FIG. 2A, the steam cooker containing three cooking trays;

FIG. 3C depicts a front-right side perspective section along lines A-A of FIG. 2A, the steam cooker containing no cooking trays, the front and rear doors in an open position, and a portion of the rack being omitted for clarity

FIG. 3D depicts a side elevation section view along lines A-A of FIG. 2A, the steam cooker containing no cooking trays, the front and rear doors in an open position, and a portion of the rack being omitted for clarity;

FIG. 4 depicts a front-left side perspective view of the steam cooker of FIG. 1 with the left side of the housing removed for clarity;

FIG. 5 depicts a magnified view of a temperature sensor;

FIG. 6 is a graph depicting the measured temperature of food as compared to measured wet bulb and dry bulb temperatures during an exemplary cooking process, the graph displaying temperature (° F.) on the y-axis and time (minutes) on the x-axis; and

FIG. 7 is an electrical schematic of the steam cooker.

### DETAILED DESCRIPTION OF THE PREFERRED EMBODIMENTS

For the purposes of promoting an understanding of the principles of the invention, reference will now be made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to “advantages” provided by some embodiments of the present invention, other embodiments may not include those same advantages, or may include different advantages. Any advantages described herein are not to be construed as limiting to any of the claims.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

The term “steam” is used herein to refer to water vapor heated above ambient temperature, and is not limited to water changed into this form by boiling. As such, the disclosed steam cooker may be interpreted as a heated water vapor cooker and “steam” may be present at temperatures less than the boiling point of water. This broad usage of the word “steam” is common in the food preparation industry.

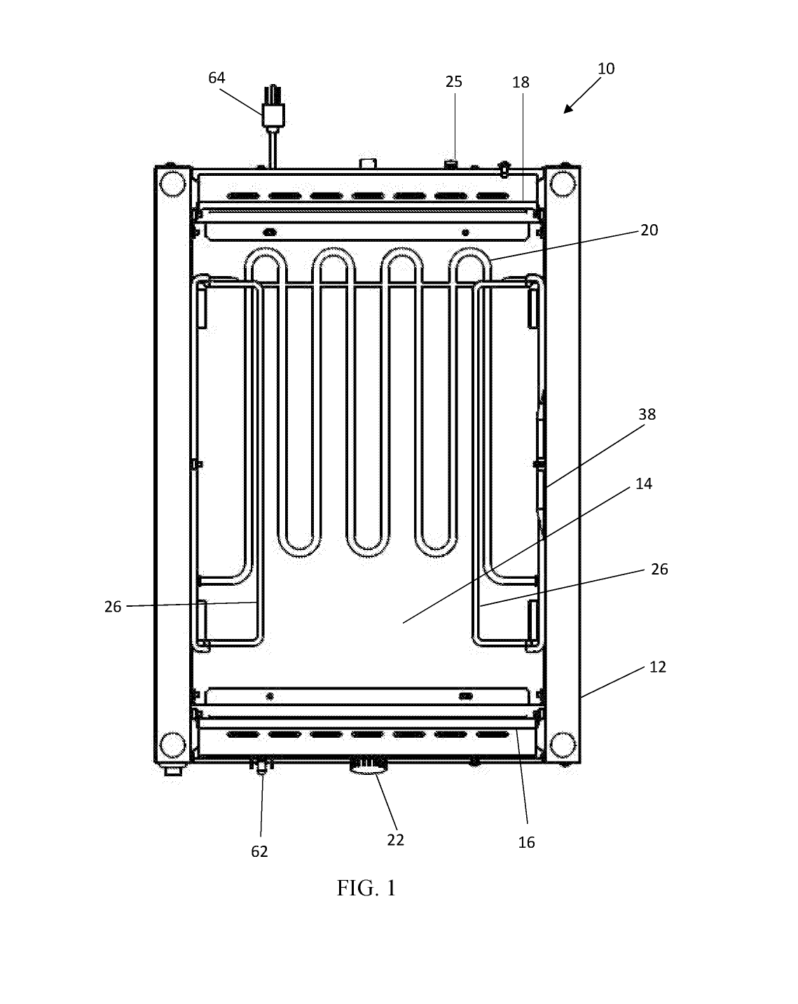

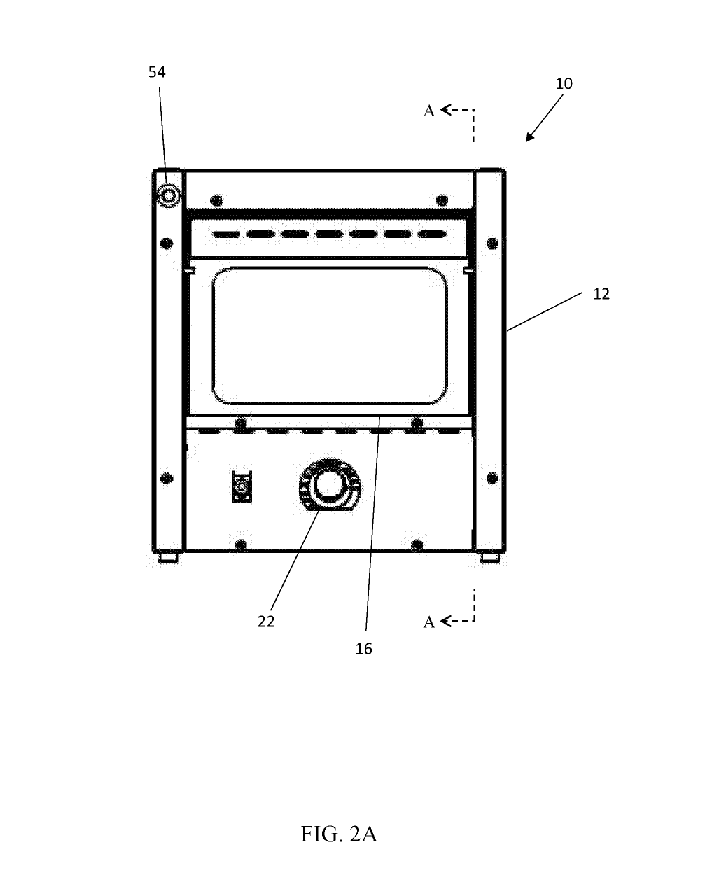

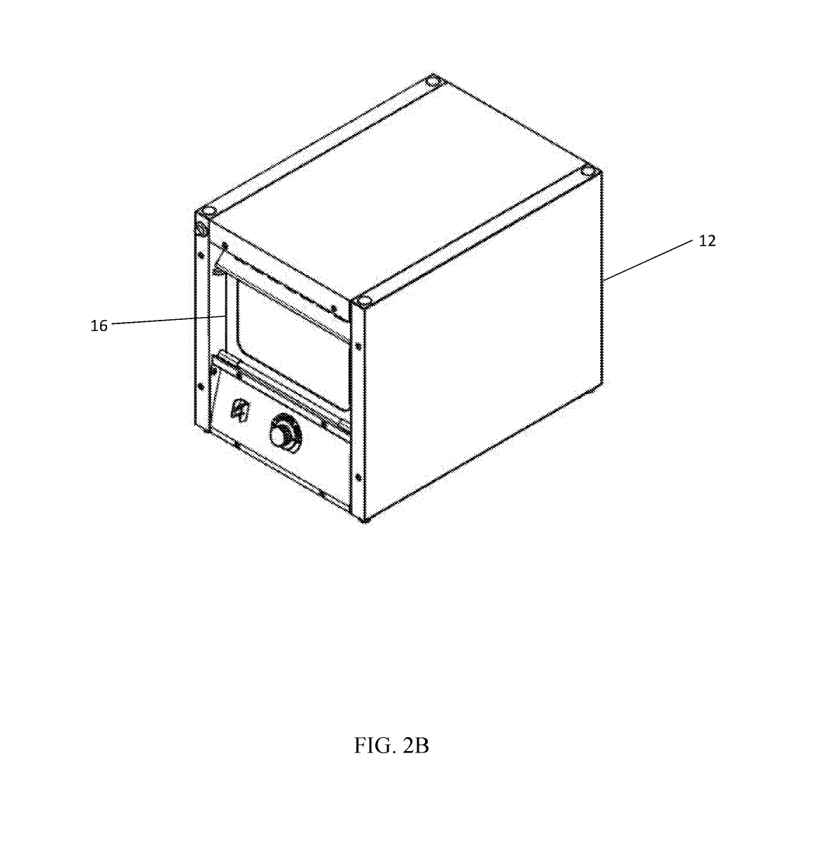

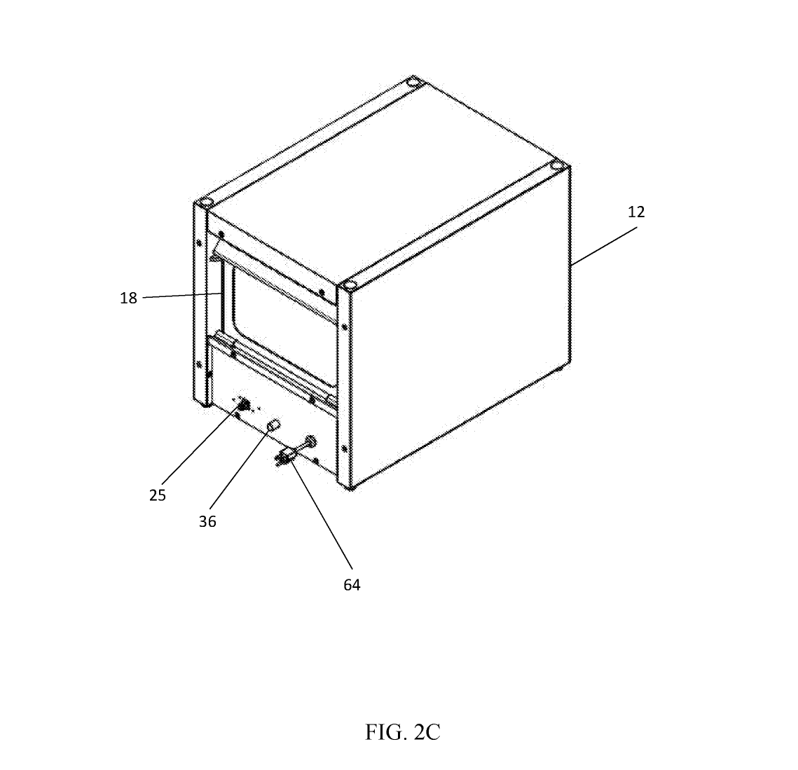

Referring to FIGS. 1, 2A-2C, 3A-3D, and 4, a first embodiment of a steam cooker 10 is shown having housing 12 including an insulated, sealable chamber 14. In the depicted embodiment, the housing 12 includes opposing front and rear doors 16, 18 providing access to the chamber 14. In other embodiments, the steam cooker may include a single hinged door, one or more sliding doors, or other means for reversibly opening and sealing the chamber. A heater 20 is positioned within the chamber 14. Preferably, the heater 20 is a water-resistant radiant heat source configured to increase the temperature within the chamber by convection, and is controlled by a thermostat 22 in electrical communication with the heater 20. Preferably, the heater 20 is formed of a heat-resistant and water-resistant material, such as incalloy (an alloy of iron, nickel, and chromium) or other suitable material. In some embodiments, the thermostat 22 is a bulb and bellows style thermostat.

The chamber 14 further includes at least one inlet 24 for introducing water vapor into the chamber 14. In certain embodiments, the water vapor is introduced in the form of a mist at or near room temperature. In some embodiments, the at least one inlet 24 is at least one nozzle, such as a misting nozzle, which mixes liquid water and air to provide a spray of water vapor. In the depicted embodiment, the at least one inlet 24 is connected to a port 25 on the rear of the housing, whereby a water line may be attached to the port 25 to provide water from an external source. In other embodiments, the at least one inlet is connected to a water line providing water from a water storage tank within the housing. In certain embodiments, the at least one inlet 24 is positioned and oriented within the chamber 14 to direct water vapor onto or in proximity to the heater 20. In further embodiments, the at least one inlet 24 is positioned and oriented to direct water vapor directly onto the heater 20.

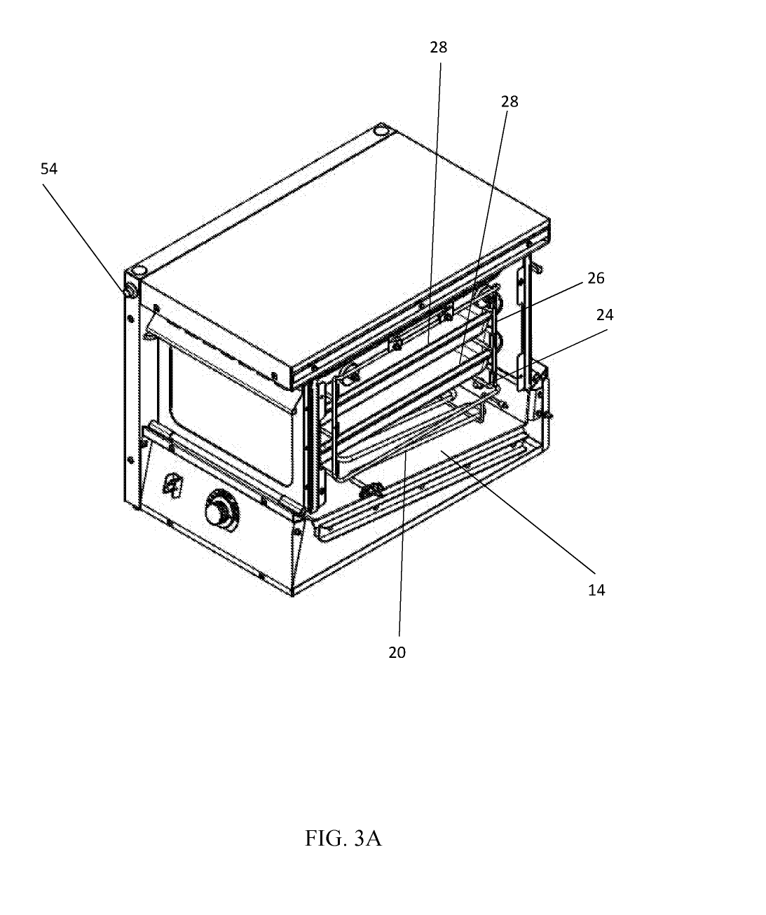

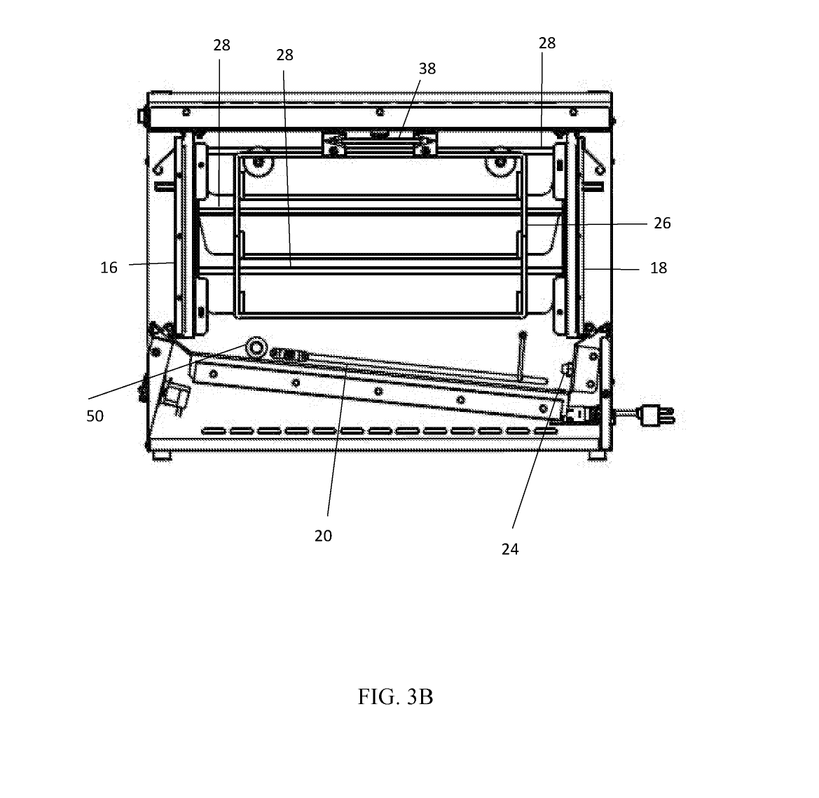

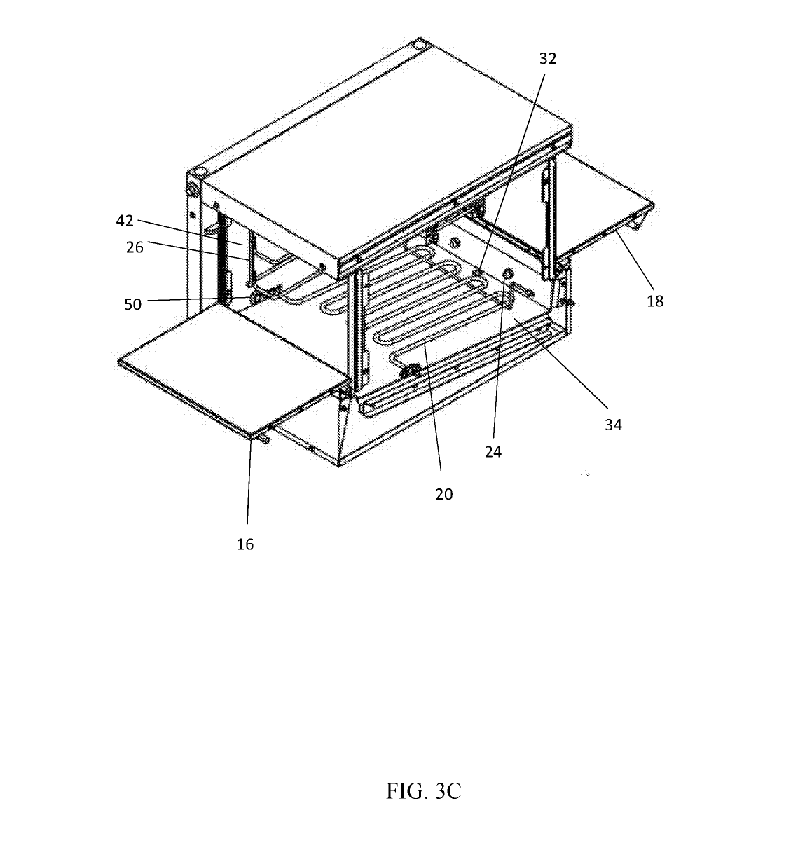

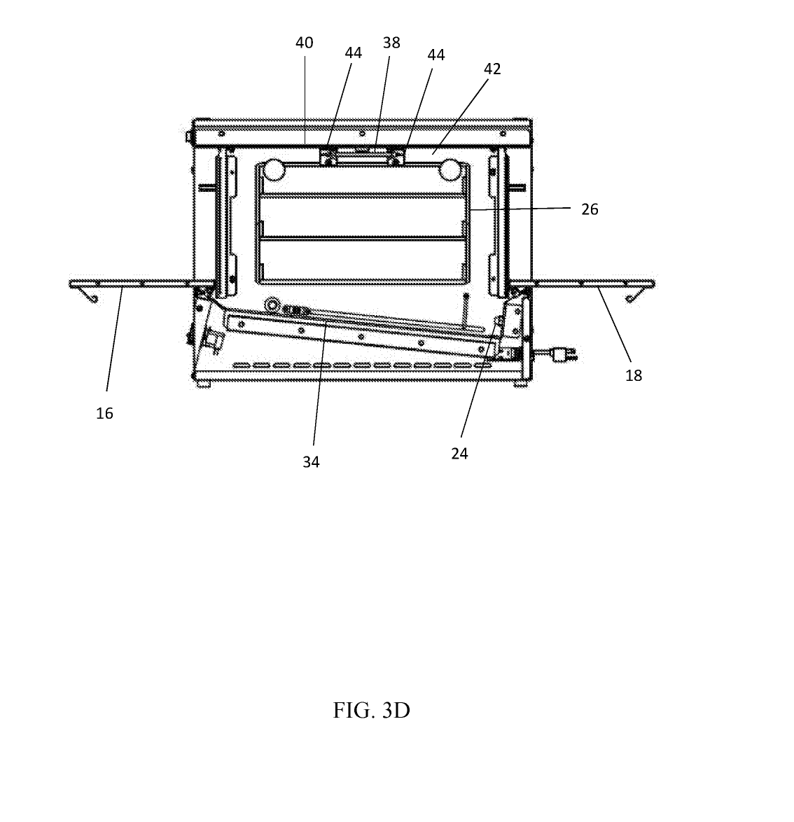

Chamber 14 preferably includes one or more racks, shelves, hangers, stands or other means for supporting pans, trays, dishes, baskets or other cookware used to hold food. In the embodiment depicted in FIGS. 1 and 3A-3D, the chamber 14 includes a rack 26 configured to support three cooking trays 28 in a vertically stacked configuration. In other embodiments, the chamber 14 may include a means for supporting cookware configured to support one, two, three, or more cooking pans, trays, dishes, baskets or other cookware in a vertical stack, side-by-side arrangement, front-to-back arrangement or other configurations.

In usage, food is placed on one or more cooking trays 28 and the cooking trays 28 are inserted into the chamber 14 onto the rack 26. The chamber 14 is then sealed by closing the front and rear doors 16, 18. A user activates the steam cooker 10, causing water vapor to be introduced into the chamber 14 via the at least one inlet 24. Activating the steam cooker 10 also activates the heater 20, whereby heat from the heater 20 increases the temperature of the water vapor above the ambient atmospheric temperature, creating steam. The steam rises within the chamber 14 and condenses upon the comparatively cooler food, delivering its heat to the food, thereby raising the temperature of the food. The endpoint temperature of the food is controlled by setting the thermostat 22 to a desired temperature. In some embodiments, the desired temperature corresponds to a vapor pressure less than the atmospheric ambient water vapor pressure, such that the desired temperature is less than the boiling point of water.

The chamber 14 includes a conduit 30 having a first opening 32 located at or in proximity to the bottom 34 of the chamber 14, and a second opening 36 external to the steam cooker 10. As water accumulates within the chamber 1 from condensation of the water vapor, it drains out through the conduit 30, exiting the steam cooker 10. The acceptable level of water within the chamber 14 can be predetermined by positioning the first opening 32 within the chamber 14. A chamber 14 with the first opening 32 at a comparatively higher elevation will allow more water to accumulate within the chamber 14 before draining begins than a chamber 14 with the first opening 32 at a comparatively lower elevation. In the depicted embodiment, the first opening 32 of the conduit 30 is positioned at approximately the lowest point on the downward-sloping bottom 34 of the chamber 14 to facilitate drainage and reduce the accumulation of water within the chamber 14.

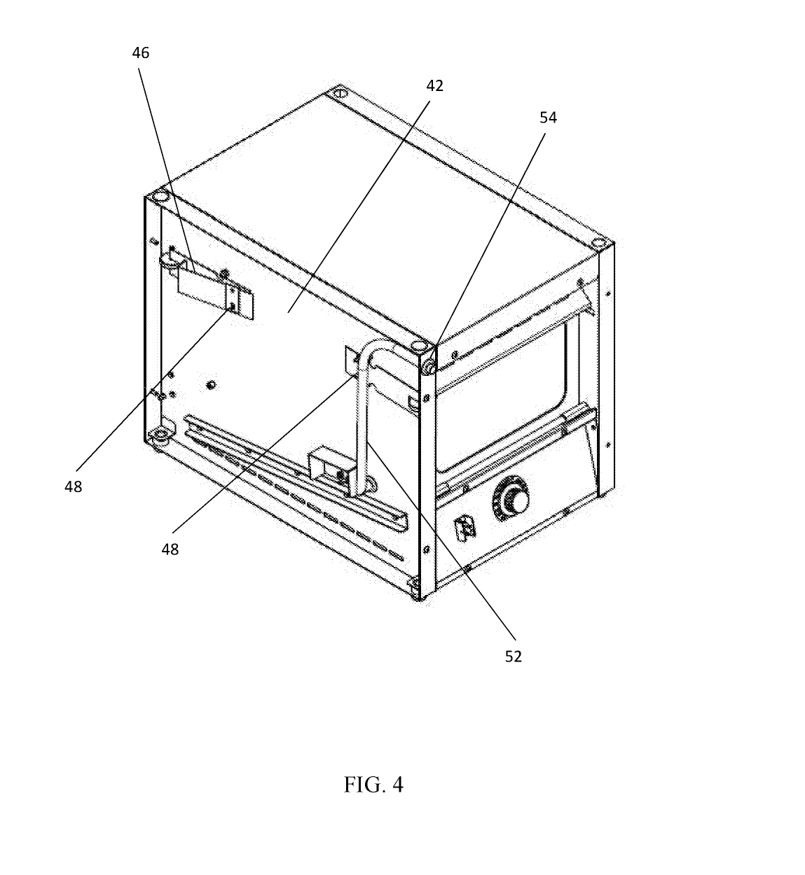

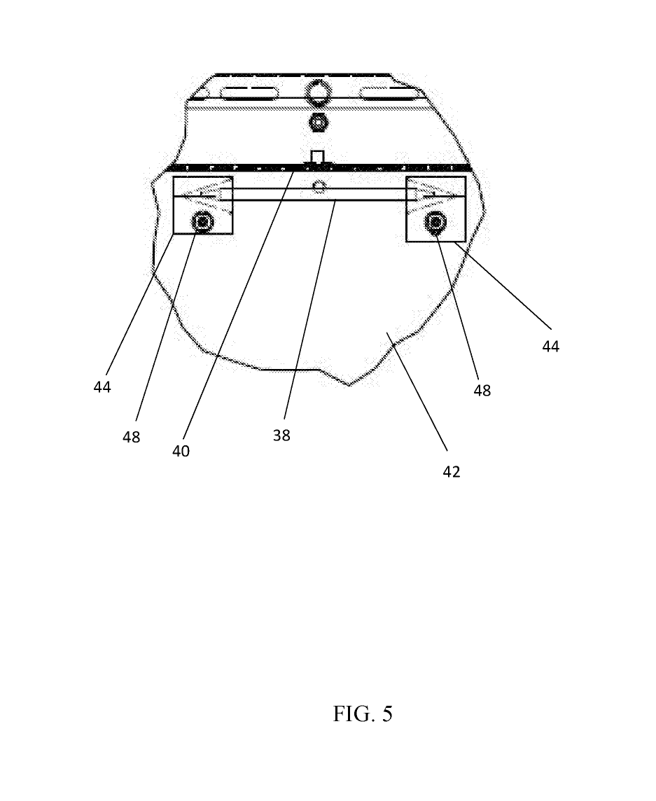

The steam cooker 10 includes a temperature sensor 38 positioned within the chamber 14. In some embodiments, the temperature sensor 38 is a temperature-sensing bulb that detects the wet bulb temperature. Typical foods have high water content, such that foods equilibrate with the wet bulb temperature of the surrounding environment, not the dry bulb temperature. The temperature sensor 38 is in electronic communication with the thermostat 22 and control circuitry for the steam cooker 10, the control circuitry, temperature sensor 38 and thermostat 22 collectively comprising the control system of the steam cooker 10. When water vapor condenses within the chamber 14, it condenses on the temperature sensor 38. In certain embodiments, temperature sensor 38 is positioned at or near the top 40 of the chamber 14. In the depicted embodiment, the temperature sensor 38 is attached to a panel 42 defining one of the sides of the chamber 14, at a location on the panel 42 adjacent to the top 40. Referring now to FIGS. 4 and 5, the temperature sensor 38 is attached to the panel 42 by at least one bracket 44 or other suitable means for attachment. In other embodiments, the temperature sensor 38 may be attached to the top 40 or elsewhere within the chamber 14.

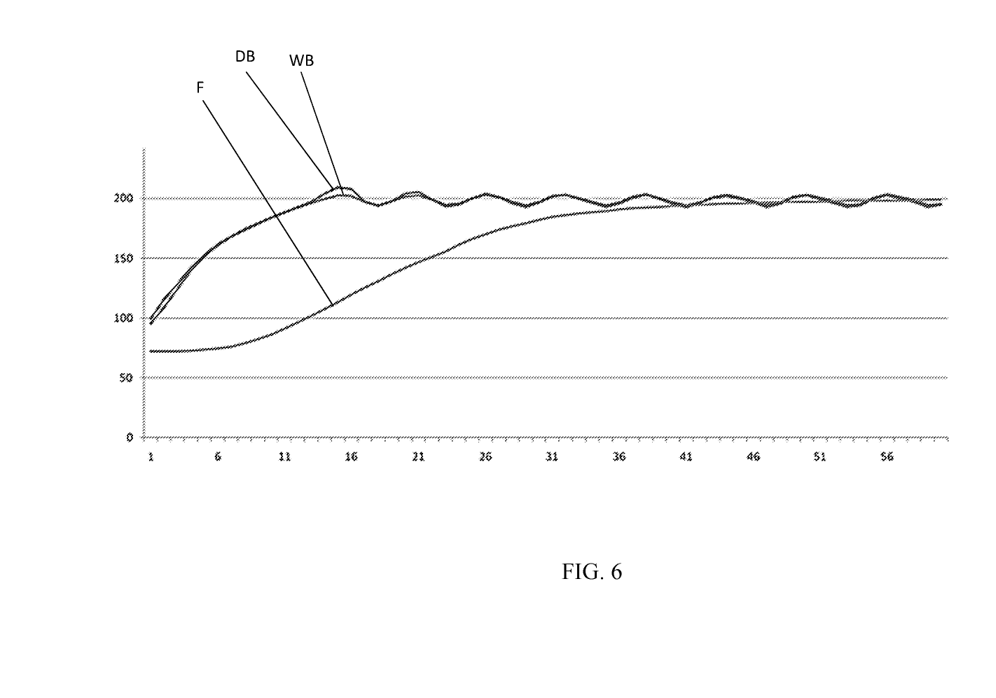

A heat conductor 46 is positioned exterior to the chamber 14 on the panel 42 opposite the temperature sensor 38 and the at least one bracket 44. Fasteners 48, such as screws or bolt and nut assemblies, fasten the at least one bracket 44 and heat conductor 46 together, with the panel 42 located therebetween. The heat conductor 46 extends from the panel 42 to the housing 12 (the left side of the housing would obscure the heat conductor and is omitted from FIG. 4). In some embodiments, the heat conductor 46 is formed of a material with high thermal conductivity, such as, for example, aluminum or copper. The temperature sensor 38 is operatively connected to the heat conductor 46 such that, when the interior of the chamber 14 is at an elevated temperature compared to ambient atmospheric temperature, conduction between the temperature sensor 38 and the heat conductor 46, and between the heat conductor 46 and the housing 12 causes the surface of the sensor 38 to remain at a lower temperature relative to the interior of the chamber 14. Heated water vapor within the chamber 14 condenses upon the comparatively cool temperature sensor 38, causing the temperature sensor 38 to be wetted and act as a wet bulb sensor. When the steam cooker 10 is in use, control circuitry activates heater 20 when the temperature sensor 38 detects a wet bulb temperature below the desired temperature set by the operator, and deactivates heater 20 when the temperature sensor 38 detects that the desired temperature has been reached or exceeded. An example of this cooking process is depicted in FIG. 6, wherein activation of the heater at the beginning of the cooking period causes the measured wet bulb temperature “WB” and dry bulb temperature “DB” to increase until they reach and exceed the desired temperature of 200° F. At this time, the heater is deactivated, and the measured WB and DB decrease beneath 200° F., upon which the heater is reactivated, increasing the temperature again. Measured temperature of food “F”, a potato, in this experiment, increases over time until it equilibrates with WB.

Steam naturally rises to the top 40 of the chamber 14. Food in the tray 28 closest to the top 40 of the chamber 14 reaches a vapor pressure equilibrium with the generated steam, such that the temperature of the food substantially equals the temperature of the steam. The steam then builds downwards until it reaches below the elevation of the lowest food tray 28 and all food is heated to the temperature of the steam, which equals the desired temperature. An atmospheric vent 50 is located in proximity to the bottom 34 of the chamber 14. As the steam builds downwards, after food in the bottom-most tray 28 is heated to the selected temperature, the steam will reach the vent 50. In preferred embodiments, the vent 50 is located below the lowest cooking tray 28 but above the first opening 32 of the conduit 30 such that liquid water accumulating in the chamber 14 exits via the conduit 30 not the vent 50. Once steam builds downward to the level of the vent 50, the steam enters the vent 50. Vent 50 is the opening of a passage 52 extending from the chamber 14 to an egress 54 located on the exterior of the housing 12. Steam passes from the chamber 14, through the passage 52, and exits to the atmosphere outside the steam cooker 12 via the egress 54. In some embodiments, the egress 54 is located above the vent 50 such that the natural tendency of steam to rise will cause steam entering the vent 50 to exit via the egress 54. The exiting steam is visible to an observing operator of the steam cooker 10 and serves as a visible indicator that the food within the chamber has reached the desired temperature. The disclosed apparatus and method for cooking are consistent with US Department of Agriculture Appendix A “Compliance Guidelines For Meeting Lethality Performance Standards For Certain Meat And Poultry Products” for serving specific foods at temperatures as low as 130° F. with effective reduction of Salmonella bacteria.

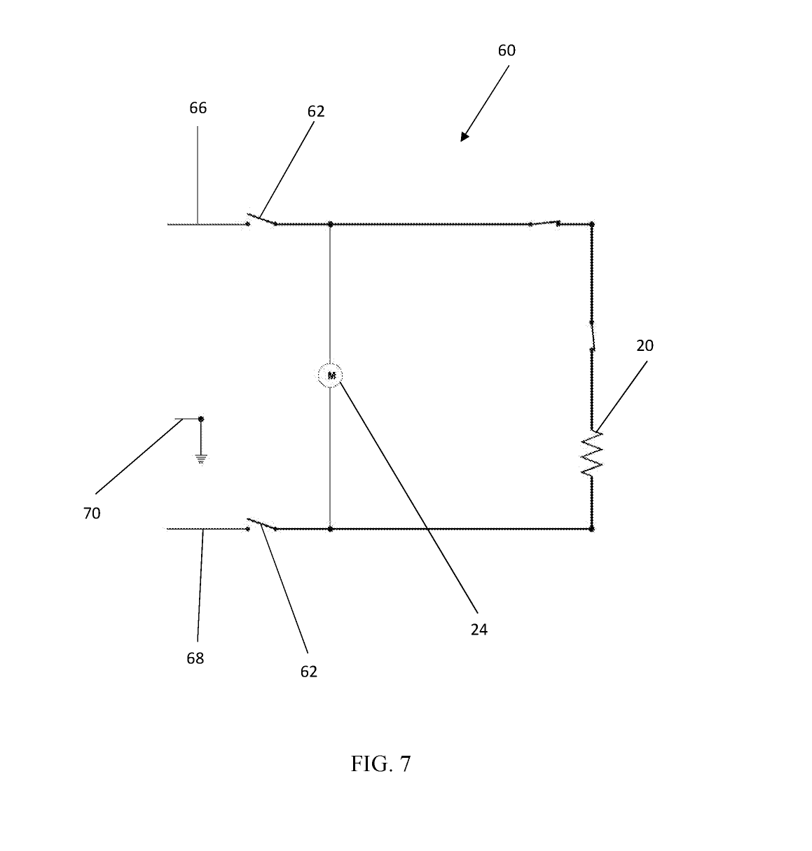

FIG. 7 depicts an embodiment of an electrical schematic 60 for a steam cooker 10. As the electrical on/off switch 62 is turned on, electrical current flows to both the resistance heater 20 and the at least one inlet 24, identified here as a mister or “M.” Current may be provided by a standard three-prong power plug 64 including live 66, neutral 68, and ground 70 wires, the plug being connected to a power socket, or by other means known in the art. Upon activation, the at least one inlet 24 delivers water mist in proximity to or directly on the heater 20. Heat from the heater 20 increases the temperature of the water vapor from a mist at or near ambient atmospheric temperature to steam. The steam substantially fills the chamber 14, exposing food and the wet bulb temperature sensor 38 to a saturated atmosphere at elevated temperatures, causing heated water vapor to condense upon the food thereby raising the temperature food. Water vapor from the food (typical foods, such as meat, vegetables and fruit contain high water contents) maintains an equilibrium vapor pressure with the wetted bulb, such that the temperature sensor 38 reflects the temperature of the food. In some embodiments, the thermostat 22 allows for a user to set a temperature within the range of 100° F. to 210° F. In other embodiments, the temperature may be set within a narrower or broader range of temperatures, such as within the range of 90° F. to 212° F. or within 120° F. to 190° F., or within 130° F. to 180° F. or within equivalent temperature ranges measured in Celsius, Kelvin or Rankine. In some embodiments, the upper boundary of the temperature range is equal to or greater than the boiling point of water. In further embodiments, the upper boundary of the temperature range is less than the boiling point of water.

In the disclosed steam cooker 10, the delivery of steam to food can begin within several seconds of activation of the heater 20 and delivery of the water vapor. In contrast, typical steam cookers heat a volume of water to boiling to create steam, then deliver the steam into the food chamber. For example, one embodiment of the disclosed steam cooker designed to accommodate three standard-sized food trays has a chamber volume of 2.67 cubic feet. A typical steam cooker with similar sized chamber volume would require significantly more energy and approximately 30 minutes heating time before delivering steam to food. In some embodiments, the disclosed steam cooker 10 requires less than 500 watts, less than 200 watts, or less than 100 watts per pound of food to cook food within the chamber. It has been determined experimentally that approximately 56 watts per pound of food is required to cook most common foods in the disclosed steam cooker 10. Therefore, a steam cooker sized to contain three standard sized food trays, as disclosed in the first embodiment, where the trays collectively hold approximately 10 pounds of food, requires approximately 560 watts for cooking. This is significantly lower than the approximately 6 kilowatts to 9 kilowatts required by a typical steam cooker of approximately similar dimensions to cook a similar amount of food. Without being tied to theory, heating water vapor to temperatures less than the boiling point of water requires less energy than the phase change required to convert liquid water to gas.

The foregoing detailed description is given primarily for clearness of understanding and no unnecessary limitations are to be understood therefrom for modifications can be made by those skilled in the art upon reading this disclosure and may be made without departing from the spirit of the invention. Although specific spatial dimensions are stated herein, such specific quantities are presented as examples only.

Appended hereto, beginning on the following page, are one or more representative claims. Since the present application is a provisional application, no claims are required. Thus, by presenting the following representative claims, it is the applicants' intention that the representative claims be considered part of the disclosure of the invention only, and not a limitation, with respect to the range of equivalents or scope, or any claims that might ultimately issue in any application claiming priority to this provisional application.

What is claimed is:

1) A steam cooker comprising:
a housing including an exterior and a sealable chamber within the housing, the chamber having a top and a bottom;
a heater connected to the chamber;
at least one inlet for delivering water vapor into the chamber; and
a vent providing atmospheric communication between the chamber and the exterior; and
a control system connected to the heater and the at least one inlet, the control system controlling the heater to add heat to the chamber and controlling the at least one inlet to deliver water vapor into the chamber.

2) The steam cooker of claim 1, further comprising a conduit having a first opening in the chamber and a second opening in the exterior of the housing.

3) The steam cooker of claim 2, wherein the first opening of the conduit is positioned below the vent within the chamber.

4) The steam cooker of claim 1, wherein the heater is located within the chamber.

5) The steam cooker of claim 4, wherein the at least one inlet is configured to deliver water vapor onto the heater.

6) The steam cooker of claim 4, wherein the heater is configured to heat the water vapor within the chamber.

7) The steam cooker of claim 4, wherein the water vapor is delivered into the chamber at about room temperature.

8) The steam cooker of claim 1, wherein the control system includes a temperature sensor for detecting a chamber temperature.

9) The steam cooker of claim 8, wherein the control system includes a thermostat for setting a desired temperature.

10) The steam cooker of claim 9, wherein the control system activates the heater when the chamber temperature is less than the desired temperature and deactivates the heater when the chamber temperature is equal to or exceeds the desired temperature.

11) The steam cooker of claim 8, wherein the temperature sensor is located within the chamber.

12) The steam cooker of claim 8, wherein the temperature sensor is operatively connected to a heat conductor.

13) A method for cooking, comprising:
placing food within a chamber;
providing water vapor into the chamber;
heating the water vapor within the chamber; and
contacting the food with the heated water vapor.

14) The method of claim 13, further comprising:
establishing a desired temperature; and
measuring a chamber temperature within the chamber; and
wherein said heating occurs when the chamber temperature does not equal or exceed the desired temperature.

15) The method of claim 14, wherein said measuring a chamber temperature includes measuring a wet bulb chamber temperature.

16) The method of claim 13, further comprising:
determining completion of cooking; and
removing food from the chamber after said determining.

17) The method of claim 16, wherein said determining includes detecting egress of water vapor from the chamber.

18) The method of claim 17, wherein said detecting includes observing egress of water vapor from the chamber.

19) The method of claim 13, wherein the desired temperature is less than the boiling point of water.

20) The method of claim 13, wherein said heating includes contacting a heater located within the chamber with the water vapor.
